(19) United States
(12) Patent Application Publication
(10) Pub. No.: US 2006/0048039 A1
(43) Pub. Date: Mar. 2, 2006

(54) Method, system and storage medium for increasing storage capacity

(75) Inventors: Gerald G. Barrett, Austin, TX (US); Brad L. Brech, Rochester, MN (US); Lee D. Cleveland, West Concord, MN (US); James R. Gathman, Rochester, MN (US); James A. O'Connor, Ulster Park, NY (US)

Correspondence Address: CANTOR COLBURN LLP, 55 GRIFFIN ROAD SOUTH, BLOOMFIELD, CT, 06002, US

(73) Assignee: International Business Machines Corporation, Armonk, NY (US)

(21) Appl. No.: 10/853,424

(22) Filed: May 25, 2004

(51) Int. Cl. H04L 1/00

(52) U.S. Cl. 714/799

(57) ABSTRACT

A method for adjusting storage capacity of a storage device includes obtaining a key corresponding to a desired storage capacity, the key being generated in response to information particular to a storage device. The key and the desired storage capacity are stored on the storage device. The key is verified in response to the desired storage capacity and the information particular to the storage device. If the key is verified, the storage capacity of the storage device is set to the desired storage capacity.

### BACKGROUND OF THE INVENTION

The present disclosure relates in general to storage management and in particular to methods, systems and storage media for increasing storage capacity. Computer systems often require a considerable amount of nonvolatile disk storage to preserve software, programs and other data that can not fit in the smaller more costly RAM memory and that otherwise would be lost when the system power is turned off. At present, it is common for these storage systems to be built using a large number of Hard Disk Drives (HDDs). HDDs are constructed using one or more disk shaped platters coated with a magnetic material. The disk platters spin at a fixed speed and a movable arm with a read/write head is directed to specific locations on the disk to write data or read data. The head assembly glides just above the surface of the platter. During a data write operations the head applies an electric field to a specific location on the disk creating a substantially permanent magnetic field in a specific direction. If the field points in one direction it represents a binary “1” and if it points in the other direction it represents a binary “0”. The head assembly is designed to read stored data by sensing the small current induced in the head assembly by the magnetic field when it passes over the magnetized location on the platter. When the HDD is powered off, data is preserved by a magnetic signature, the bits of information at specific locations on the disk.

Each HDD platter is formatted, pre-written, with data used by the electronics in the HDD to store and retrieve data. The platters are partitioned into concentric circles called tracks that are coincident with areas over which the head glides when the arm assembly remains motionless. Each track is further partitioned into sectors. Each sector contains a larger area for the customer data as well as header and trailer information used by the HDD electronics during the data storing and retrieval process. Data read and write times called latency are not fixed and predictable as they are in RAM. The latency, to a large extent, is a function of the seek time, the time it takes the arm to reposition the head over the track where the data is to be stored or retrieved. That time is variable and a function of the last position of the arm.

HDDs are typically designed as self contained assemblies that can be plugged into a standard slot in the computer chassis or in a separate storage chassis. Separate storage drawers typically hold anywhere from a half dozen to as many as 50 or more individual HDDs. A storage chassis can be either a stand-alone assembly or a rack mountable unit to allow multiple drawers to be placed into a single rack creating a relatively large array of HDDs in a small physical foot print. Drive density per unit area floor space is a competitive metric used in the industry to help potential customers compare offerings from different vendors.

The storage capacity of computer systems often needs to be increased. Currently, adding storage capacity involves purchasing additional HDDs and either scheduling time for a customer engineer to bring the new equipment and install the HDDs in the system or waiting for HDDs to be shipped directly to the customer location and installed by the customer. In addition, if the customer's storage drawers are already filled to capacity, new storage drawers would need to be purchased and installed. Additional racks might also be required.

There are programs available designed to facilitate increasing storage capacity. Recently, pSeries has a “Step up” program where additional drawers are purchased at a fraction of the full purchase price on the condition that they be activated within 1 year. Only a small number of customers take advantage of this and there are accounting accrual issues associated with having high value equipment, yet to be fully enabled and purchased, installed at customer locations. Thus, there is a need in the art for a technique for increasing storage capacity of storage devices.

### SUMMARY OF THE INVENTION

One embodiment is a method for adjusting storage capacity of a storage device including obtaining a key corresponding to a desired storage capacity, the key being generated in response to information particular to a storage device. The key and the desired storage capacity are stored on the storage device. The key is verified in response to the desired storage capacity and the information particular to the storage device. If the key is verified, the storage capacity of the storage device is set to the desired storage capacity.

Another embodiment of the invention is a system for adjusting storage capacity of a storage device. The system includes a computer system in communication with a host system over a network. The computer system obtains a key from the host system. The key corresponds to a desired storage capacity and is generated in response to information particular to the storage device. The computer system stores the key that corresponds to the desired storage capacity on the storage device. The computer system attempts to verify the key in response to the desired storage capacity and the information particular to the storage device. If the key is verified, the storage capacity of the storage device is set to the desired storage capacity.

Another embodiment of the invention is a computer program product for adjusting storage capacity of a storage device. The computer program product includes a storage medium readable by a computer system for performing a method including obtaining a key corresponding to a desired storage capacity, the key being generated in response to information particular to a storage device. The key and the desired storage capacity are stored on the storage device. The key is verified in response to the desired storage capacity and the information particular to the storage device. If the key is verified, the storage capacity of the storage device is set to the desired storage capacity.

### BRIEF DESCRIPTION OF THE DRAWINGS

Referring to the exemplary drawings wherein like elements are numbered alike in the accompanying Figures:

FIG. 1 depicts a system for increasing storage capacity in an embodiment of the invention;

FIG. 2 is a flowchart of a process for obtaining a key for increasing storage capacity in an embodiment of the invention;

FIG. 3 is a flowchart of a process for verifying a key for increasing storage capacity in an embodiment of the invention;

FIG. 4 depicts a storage medium formatted for increasing capacity in an embodiment of the invention; and

FIG. 5 depicts a storage medium formatted for increasing capacity in an alternate embodiment of the invention.

### DETAILED DESCRIPTION OF THE INVENTION

Embodiments of the invention make it easier and more convenient to add storage capacity to a computer system through the use of incremental reserve storage capacity that can be rapidly added to the system any time of the day or night. Currently, increasing the storage capacity of a computer system can take days or weeks. Embodiments of the invention are useful for customers with business environments that can change rapidly and where change is difficult to predict. Embodiments of the invention involve incrementally enabling small portions of the total available storage capacity of storage devices via downloadable software keys. This makes adding storage capacity much faster, easier and more convenient since no physical device need be added to system during the upgrade.

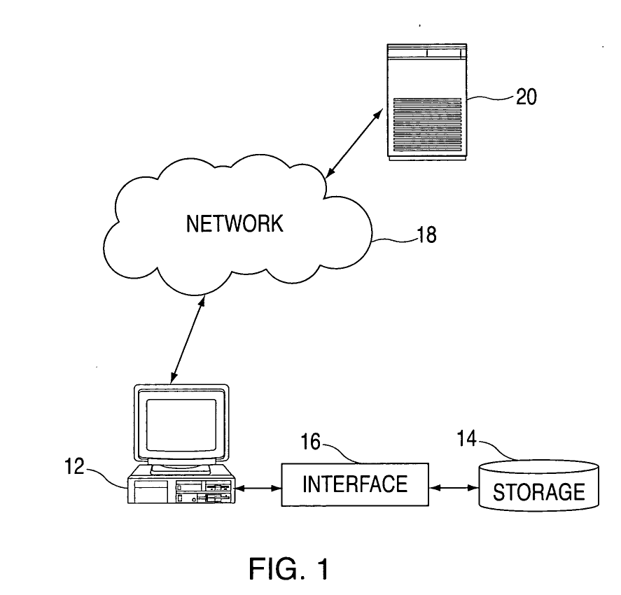

FIG. 1 is a block diagram of a system for increasing storage capacity in an embodiment of the invention. The system includes a computer system 12 connected to a storage device 14 through an interface 16. Computer system 12 may be any type of computing system including a personal computer, a server, a cluster of computers, etc. The storage device 14 may be a stand-alone hard disk drive, or one hard disk drive among a number of hard disk drives in a drawer or stack. As described in further detail herein, storage device 14 may contain a key that indicates the storage capacity of the storage device 14.

The computer system 12 communicates with a host system 20 over a network 18. The network may be any type of known network including a local area network (LAN), wide area network (WAN), global network (e.g., Internet), intranet, etc. and be wireless and/or wired. The host system 20 may be any known computer system such as a commercially available server operating as a web server. The computer system 12 may access the host system 20 though known user applications such as a web browser. The interface 16 may be any known type of peripheral interface such as a small computer system interface (SCSI).

In order to increase the capacity of the storage device 14, a key is retrieved from the host system 20 and stored on the storage device 14. The key indicates the available capacity of the storage device. By obtaining one or more keys, a user can increase storage capacity without requiring the addition of new physical hardware.

A number of techniques may be used to generate the key. A key may be created via a hashing function, an algorithm, whereby different output codes are generated for different input codes. In exemplary embodiments, the key is a function of the part number of the storage device 14, serial number of the storage device 14, and desired capacity. For purposes of illustration, assume storage device 14 is a 146 GB disk with 4 partitions of 32 GB of incremental storage that can be added. In practice, the host system 20 executes an algorithm that generates the key. In one embodiment, the host system 20 generates a key based on the least significant 4 digits of the product of the capacity, part number, and serial number. The table below illustrates exemplary keys.

| DESIRED | | SERIAL | PART | | | |
|---|---|---|---|---|---|---|
| CAPACITY | | NUMBER | NUMBER | PRODUCT | KEY | |
| 36 | GB | 321 | 548 | 6332688 | 2688 | (no key |
| | | | | | | required) |
| 73 | GB | 321 | 548 | 12841284 | 1284 | |
| 109 | GB | 321 | 548 | 19173972 | 3972 | |
| 143 | GB | 321 | 548 | 25154844 | 4844 | |

Since the keys are a function of the serial number and part number of the storage device 14, they are device specific. That is, they are sufficiently different that it prevents using a key from one device to activate additional capacity for another devices. Further examples of keys are shown in the table below.

| DESIRED | | SERIAL | PART | | | |
|---|---|---|---|---|---|---|
| CAPACITY | | NUMBER | NUMBER | PRODUCT | KEY | |
| 36 | GB | 824 | 548 | 16255872 | 5872 | (no key |
| | | | | | | required) |
| 73 | GB | 824 | 548 | 32963296 | 3296 | |
| 109 | GB | 824 | 548 | 49219168 | 9168 | |
| 143 | GB | 824 | 548 | 64571936 | 1936 | |

The keys may not be unique for each device. The universe of output keys is less than the universe of inputs so the keys are not completely unique, but sufficiently unique to prevent unauthorized enablement of function. That is, there will be different combinations of capacity, serial number, and part numbers that result in the same key. Nevertheless, the keys are sufficiently unique and difficult to predict which device will have the same key without knowledge of the algorithm so that this overlap does not help someone decipher the keys.

Making the key generation algorithm more complex, lengthening the number of digits, and using characters as well as numbers are techniques that can be used to create keys that make it increasingly difficult to crack the algorithm and decipher the keys. The algorithm can also be made different for different machine types so that if the algorithm becomes known for one machine it will still not be know for another. Using microcode rather than hardware to implement the algorithm make is easy to change if necessary.

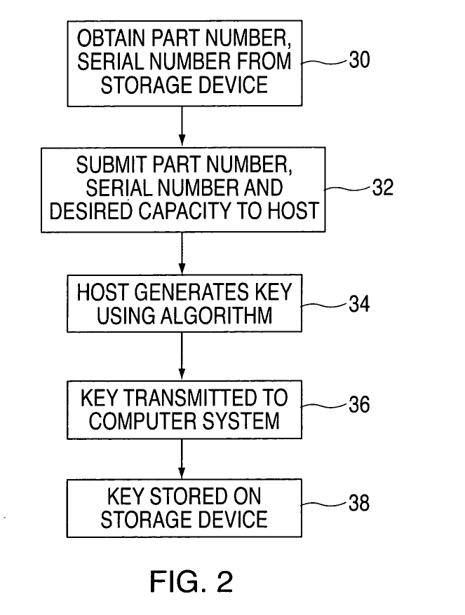

FIG. 2 is a flowchart of a process for obtaining a key in an embodiment of the invention. The process begins at step 30 where the computer system 12 obtains the part number and serial number from storage device 14. This information is read from the storage device 14 via interface 16. Existing storage devices include regions dedicated to containing this type of information (e.g., non-user data). At step 32, the part number, serial number and desired capacity is transmitted from the computer system 12 to the host system 20 over network 18. The computer system 12 requests a key for the desired capacity and pays any fees associated with obtaining the keys.

At step 34, the host system 20 generates a key enabling the desired capacity using the key generation algorithm. As described above, the key generation algorithm may generate the key based on the product of the part number, serial number and desired capacity. At step 36, the key is transmitted to the computer system 12 from the host system 20 over network 18. At step 38, the key is stored on the storage device 14 via interface 16. The key is stored on a portion of storage device 14 dedicated to non-user data such as part number, serial number, etc. It is common today to have some amount of non-user data like part numbers, serial numbers, format data, or CRC (cyclic redundancy check) stored on the devices so adding a location for a key is a simple extension of current practices. Other vital product data (VPD) is commonly found in the non-user data area. The capacity is also stored in this portion of the storage device.

Multiple keys may be used to provide several capacity increments. Storing the keys on the storage device 14 allows the keys to physically move with the storage device in the event the device was unplugged from one system and used in another system, any reserve capacity purchased and enabled by the customer would move with the storage device. Having minimum capacity activated if no key or an erroneous key is found ensures that the computer system will remain functional.

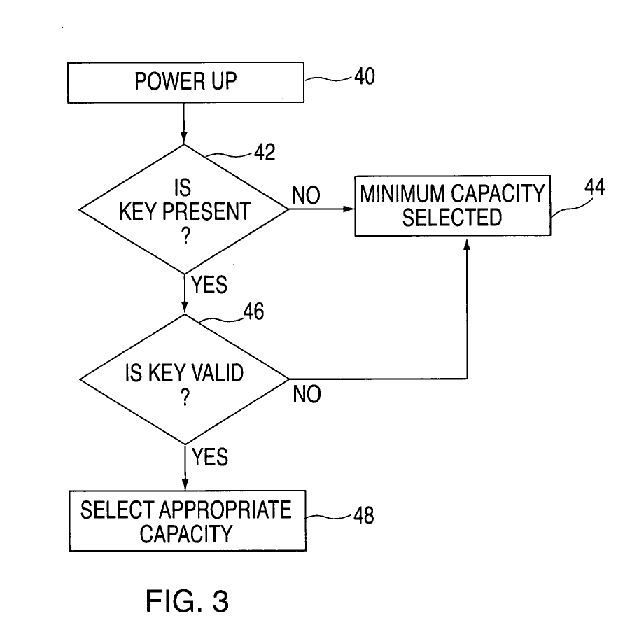

When accessing the storage device 14, the computer system 12 accesses the key to determine the storage capacity of storage device 14. FIG. 3 is a flowchart of a process for accessing storage device 14 in an exemplary embodiment. The process begins at step 40 when the computer system 12 is powered. In one embodiment, the system is rebooted in order to activate the additional incremental capacity. In other words, keys could be downloaded to the storage device 14 at any time, but the additional capacity would only enabled on a reboot. Operating systems may not recognize when device characteristics are changed on the fly so additional operating system design changes may be needed to allow reserve capacity activation without the need to reboot the system.

At step 42 the computer system 12 accesses storage device 14 through interface 16 and determines whether a key is present. The computer system 12 may look for keys at a predetermined location on the storage device 14.

If no key is present, flow proceeds to step 44 where default, minimum capacity is specified for the storage device. In an alternate embodiment, if no key is present, then the storage device is considered inactive. In the previously provided example, the default capacity is 36 Gb. If a key is present at step 42, then validity of the key is verified at step 46. Either the computer system 12 or the interface 16 executes the key generation algorithm used by the host system 20. The key generation algorithm may be implemented using software, microcode or hardware or any combination thereof. The part number, serial number and capacity are read from the storage device 14 and the key generation algorithm generates a confirmation key from this information. If the confirmation key matches the stored key, then the stored key is considered valid and flow proceeds to step 48 where the capacity is set to the stored capacity on storage device 14. If the key is not present at step 42 or is not valid at step 46, the flow proceeds to step 44 where the default, minimum capacity is specified.

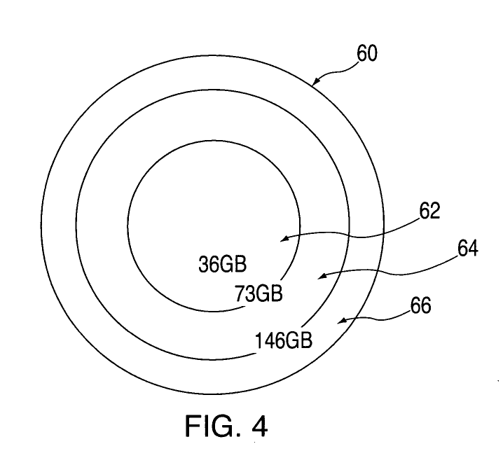

FIG. 4 illustrates one technique for allocating storage space on the storage device 14. In the example, the storage device 14 is a hard disk drive having a magnetic media platter 60. As shown in FIG. 4, the platter 60 is divided into discrete, continuous regions to define the different capacities. Region 62 provides the default, minimum amount of storage. Region 64 provides additional storage if the user has obtained the appropriate key. Region 66 provides even more storage if the user has obtained the appropriate key.

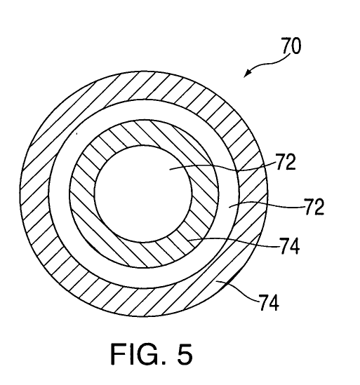

FIG. 5 depicts allocation of storage in an alternate embodiment of the invention. In this embodiment, platter 70 include regions 72 that are non-contiguous that provide the minimum amount of storage. Regions 74 are also non-contiguous and provide increased storage if the user has obtained the appropriate key.

More complex allocation of the areas of HDD platters held in reserve may be used to ensure more consistent device performance characteristics and reliability characteristics of the HDD. This more complex physical capacity partitioning of the HDD could be accomplished by allocating every 2nd or 3rd or 4th track to a particular capacity partition versus doing the allocation via concentric circles on the disk. Again, for more consistent performance considerations, allocating alternating groups of tracks of 10 or 20 consecutive tracks, for example, may be appropriate for some applications. Both approaches would not only tend to help maintain consistent performance characteristics, but also tend to improve reliability by ensuring unimpeded arm movement when only partial capacity activation was used for some time. Locating incremental storage partitions on non-concentric areas of different platters is another approach. Some of or all of these techniques would be useful in different applications environments and could be configurable during the initial installation of the HDD.

During the initial set up of the computer system or during upgrades when additional storage devices are added, the customer could elect to purchase HDDs with additional unused capacity at a price that is much less than if they had just purchased HDDs with this larger capacity fully activated. This allows customers to enable greater storage capacity easily when it is needed. Since the configurations are based on higher capacity disks, the same total capacity will reside in a smaller physical footprint. In other words, this type of disk on demand type of implementation, would provide higher density solutions whereby more total storage capacity would reside in the same physical space. Customers often will have smaller capacity HDDs and elect to purchase a new disk drawer and additional HDDs instead of replacing the smaller capacity HDDs in an existing HDD drawer with larger capacity HDDs. Customers application environments that can utilize this type of disk-on-demand solution alternative where additional reserve capacity is activated will find that they will tend to use less power, be less expensive for customers, provides a higher profit margin for the seller and tend to be more reliable since there is physically less hardware required to achieve the same total system storage capacity.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention is not to be limited to the particular embodiment disclosed as the best or only mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A method for adjusting storage capacity of a storage device, the method comprising:
obtaining a key corresponding to a desired storage capacity, said key being generated in response to information particular to a storage device;
storing said key that corresponds to said desired storage capacity on said storage device;
attempting to verify said key in response to said desired storage capacity and said information particular to said storage device;
if said key is verified, setting said storage capacity of said storage device to said desired storage capacity.

2. The method of claim 1 wherein:
if said key is not verified, setting the storage capacity of said storage device to a minimum capacity.

3. The method of claim 1 wherein:
if said key is not verified, rendering the storage device inactive.

4. The method of claim 1 further comprising:
removing said storage device from a first system;
installing said storage device in a second system;
attempting to verify said key in said second system.

5. The method of claim 1 wherein:
said storage device is a hard disk drive.

6. The method of claim 1 wherein:
said information particular to said storage device is a function of a part number for said storage device.

7. The method of claim 1 wherein:
said information particular to said storage device is a function of a serial number for said storage device.

8. The method of claim 1 wherein:
said information particular to said storage device is a function of part number and a serial number for said storage device.

9. The method of claim 8 wherein:
said key is generated by applying an algorithm to said part number, said serial number and said desired storage capacity.

10. The method of claim 9 wherein:
said algorithm is the product of said part number, said serial number and said desired storage capacity.

11. The method of claim 1 wherein:
said key corresponds to N significant digits of said product.

12. The method of claim 1 wherein:
said storage device is segmented into a first region defining a first storage capacity and a second region defining a second storage capacity.

13. The method of claim 12 wherein:
said first region is made up of non-contiguous and said second region is made up of contiguous tracks.

14. The method of claim 12 wherein:
said first region is made up of non-contiguous tracks and said second region is made up of non-contiguous tracks.

15. A system for adjusting storage capacity of a storage device, the system comprising:
a computer system in communication with a host system over a network, said computer system obtaining a key from said host system, said key corresponding to a desired storage capacity, said key being generated in response to information particular to said storage device;
said computer system storing said key that corresponds to said desired storage capacity on said storage device;
said computer system attempting to verify said key in response to said desired storage capacity and said information particular to said storage device;
if said key is verified, setting said storage capacity of said storage device to said desired storage capacity.

16. The system of claim 15 wherein:
if said key is not verified, said computer system setting the storage capacity of said storage device to a minimum capacity.

17. The system of claim 15 wherein:
if said key is not verified, said computer system rendering the storage device inactive.

18. A computer program product for adjusting storage capacity of a storage device, the computer program product comprising:
a storage medium readable by a computer system for performing a method comprising:
obtaining a key corresponding to a desired storage capacity, said key being generated it response to information particular to a storage device;
storing said key that corresponds to said desired storage capacity on said storage device;
attempting to verify said key in response to said desired storage capacity and said information particular to said storage device;
if said key is verified, setting said storage capacity of said storage device to said desired storage capacity.
